(19) United States
(12) Patent Application Publication
(10) Pub. No.: US 2015/0312716 A1
(43) Pub. Date: Oct. 29, 2015

(54) SYSTEMS AND METHODS FOR MANAGING A CONTENT FEED AT A WIRELESS NETWORK ACCESS POINT

(71) Applicant: Devicescape Software, Inc., San Bruno, CA (US)

(72) Inventors: David Fraser, Piedmont, CA (US); John Hartman, Oakland, CA (US); Jean-Marc Matteini, Campbell, CA (US)

(73) Assignee: DEVICESCAPE SOFTWARE, INC., San Bruno, CA (US)

(21) Appl. No.: 14/578,250

(22) Filed: Dec. 19, 2014

Related U.S. Application Data
(60) Provisional application No. 61/918,237, filed on Dec. 19, 2013.

(51) Int. Cl. H04W 4/02

(52) U.S. Cl. CPC H04W 4/021

(57) ABSTRACT

Systems and methods of providing a content feed in an entry site for a user device accessing a network device, such as a wireless network access device, are provided. Content items may be gathered. Whether a whether a first user device is accessing a first network device configured to provide wireless network access at a first location in a first geographical area may be determined. A first entry site for the first user device to access network resources through the network device may be managed. One or more of the content items may be selected for the first entry site based on selection criteria particular to the first location. The one or more content items may be incorporated into a first content feed. The first content feed may be provided to the user device.

### CLAIM OF PRIORITY

The present application claims benefit of U.S. Provisional Patent Application No. 61/918,237 filed Dec. 19, 2013, and entitled “Systems and Methods for Neighborhood Buzz,” which is incorporated herein by reference.

### BACKGROUND

1. Technological Field

The field generally relates to managing content at a wireless network access point. More particularly, the field relates to providing a content feed geographically targeted to a user device accessing a wireless network access point.

2. Description of Related Art

Computer networks have played an important role in modern communications. Users have grown to expect reliable computer network access at shopping malls, airports, financial districts, and densely populated areas. Although cellular networks provide data services for numerous users, many cellular data service providers charge for data use, which deters its use for lower-priority or casual purposes.

Many users have grown to rely on WiFi local area networks available at various points of interest for data. A user's experience of connecting to a WiFi network access point is often limited to verifying credentials on a network access server access port and receiving a minimalist splash screen. From the perspective of many businesses and other entities, this utilitarian experience is essentially an unused opportunity to provide interesting content to its audience.

### SUMMARY

A content gathering module may gather content items. A user device module may determine whether a first user device is accessing a first network device configured to provide wireless network access at a first location in a first geographical area. A site management module may manage a first entry site for the first user device to access network resources through the network device. A content selection module may select one or more of the content items for the first entry site based on selection criteria particular to the first location. A content providing module may incorporate the one or more content items into a first content feed, and for providing the first content feed to the user device.

The gathered content items may comprise user-generated content items generated by a second user device within the first geographical area into the first content feed. The gathered content items may comprise user-generated content items by a second user device outside the first geographical area. The gathered content items may be generated at least in part by an entity that administers a second network device within the geographical area.

The selection criteria may comprise criteria for selecting the one or more content items based on a time each of the one or more content items was generated, or based on a location each of the one or more content item was generated. The selection criteria may comprise criteria for controlling a number of the one or more content items in the first content feed.

The selection criteria may comprise first selection criteria for selecting a first content item of the one or more content items, the first content item generated within the first geographical area, and second selection criteria for selecting a second content item of the one or more content items, the second content item generated outside the first geographic area.

In an embodiment, the first selection criteria comprises criteria for selecting the first content item based on a location the first content item was generated; and the second selection criteria comprises criteria for selecting the second content item based on a time the second content item was generated.

A network device attribute module may determine the first location based on a network device identifier of the network device. The user device module may be configured to determine the first location based on location data from the user device.

In a method, content items may be gathered. Whether a whether a first user device is accessing a first network device configured to provide wireless network access at a first location in a first geographical area may be determined. A first entry site for the first user device to access network resources through the network device may be managed. One or more of the content items may be selected for the first entry site based on selection criteria particular to the first location. The one or more content items may be incorporated into a first content feed. The first content feed may be provided to the user device.

The gathered content items may comprise user-generated content items generated by a second user device within the first geographical area into the first content feed. The gathered content items may comprise user-generated content items by a second user device outside the first geographical area. The gathered content items may be generated at least in part by an entity that administers a second network device within the geographical area.

The selection criteria may comprise criteria for selecting the one or more content items based on a time each of the one or more content items was generated, or based on a location each of the one or more content item was generated. The selection criteria may comprise criteria for controlling a number of the one or more content items in the first content feed.

The selection criteria may comprise first selection criteria for selecting a first content item of the one or more content items, the first content item generated within the first geographical area, and second selection criteria for selecting a second content item of the one or more content items, the second content item generated outside the first geographic area.

In an embodiment, the first selection criteria comprises criteria for selecting the first content item based on a location the first content item was generated; and the second selection criteria comprises criteria for selecting the second content item based on a time the second content item was generated.

In various embodiments, the first location may be determined based on a network device identifier of the network device. In an embodiment, the first location may be determined based on location data from the user device.

A system may include: means for gathering content items; means for determining whether a first user device is accessing a first network device configured to provide wireless network access at a first location in a first geographical area; means for managing a first entry site for the first user device to access network resources through the network device; means for selecting one or more of the content items for the first entry site based on selection criteria particular to the first location; and means for incorporating the one or more content items into a first content feed, and for providing the first content feed to the user device.

### BRIEF DESCRIPTION OF THE DRAWINGS

FIG. 1 is a diagram of a network system that includes digital devices for managing content feeds, according to some embodiments.

FIG. 2 is a diagram illustrating details of a user device, according to some embodiments.

FIG. 3 is a diagram of a flowchart of a method for providing a content feed to a user device, according to some embodiments.

FIG. 4 is a diagram illustrating details of a network access server system, according to some embodiments.

FIG. 5 is a diagram illustrating details of a content management module, according to some embodiments.

FIG. 6 is a diagram of a flowchart of a method for providing a content feed from a network access device, according to some embodiments.

FIG. 7 is a diagram illustrating details of a geographical area containing a plurality of venues with which the systems and methods described herein can be implemented.

FIG. 8 is a block diagram of an exemplary digital device.

### DETAILED DESCRIPTION

When accessing a wireless network access point, such as a WiFi local area network compliant with the Institute of Electrical and Electronics Engineers (IEEE) 802.11 standards, the wireless network access point (network device) typically verifies the user and/or the user device. The authentication process usually involves verifying user attributes (e.g., a username and password) and/or device attributes (e.g., a device identifier). Upon authentication, many wireless network access points supply a splash screen that informs the user that the user information has been authenticated. Various embodiments of the invention may supply information relevant to the user on these splash screens.

According to some embodiments, systems and methods herein provide users accessing a wireless network with a content feed, e.g., a content feed about nearby locations (e.g., locations within a five mile or 50 mile radius), a content feed generated by users at those nearby locations (e.g., chat content), a content feed of reviews, a content feed of advertisements, a content feed of promotions, etc. The content feed and/or relevant geographic expanse may be selected according to selection criteria particular to the user location, network device access time, content generation time, content generation location, the number of available content items for the content feed, etc. In some embodiments, when there is only a few content items generated at immediately nearby location (e.g., within a five mile radius), the content feed may include content items gathered from a larger area (e.g., locations within a fifty mile radius) and/or from around the world. Various embodiments of the systems and methods allow the user to generate content items, such as comments, ratings, messages to other users, and other user-generated information, to be used as content items in the content feed, which in some embodiments may be seen by other nearby users when they attempt to access wireless networks in the nearby area or other areas.

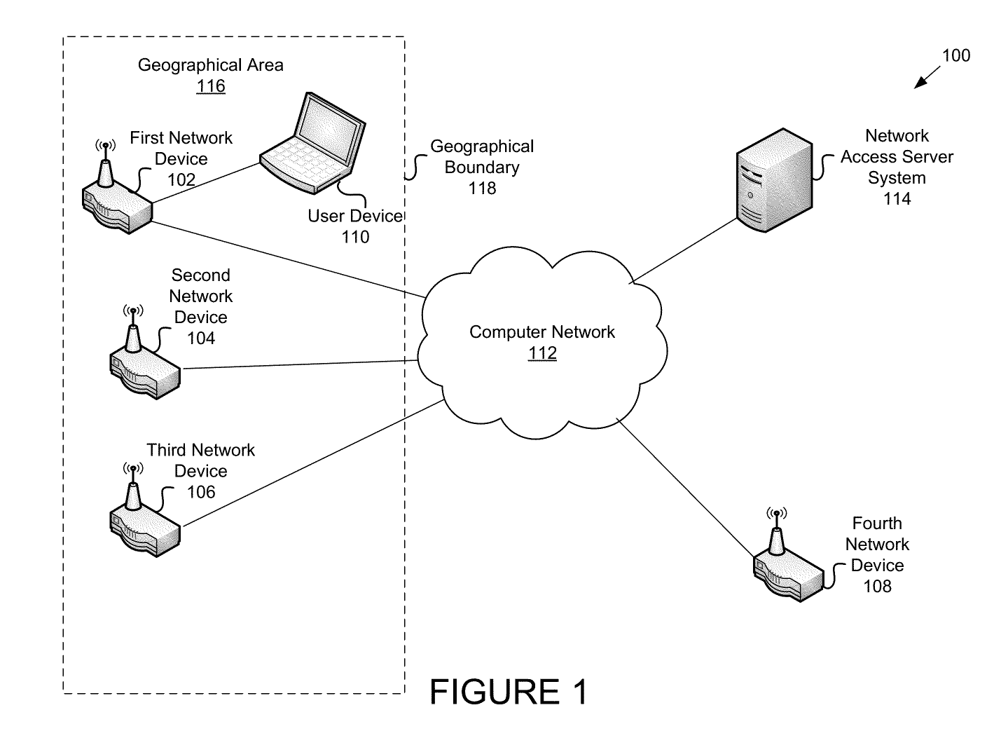

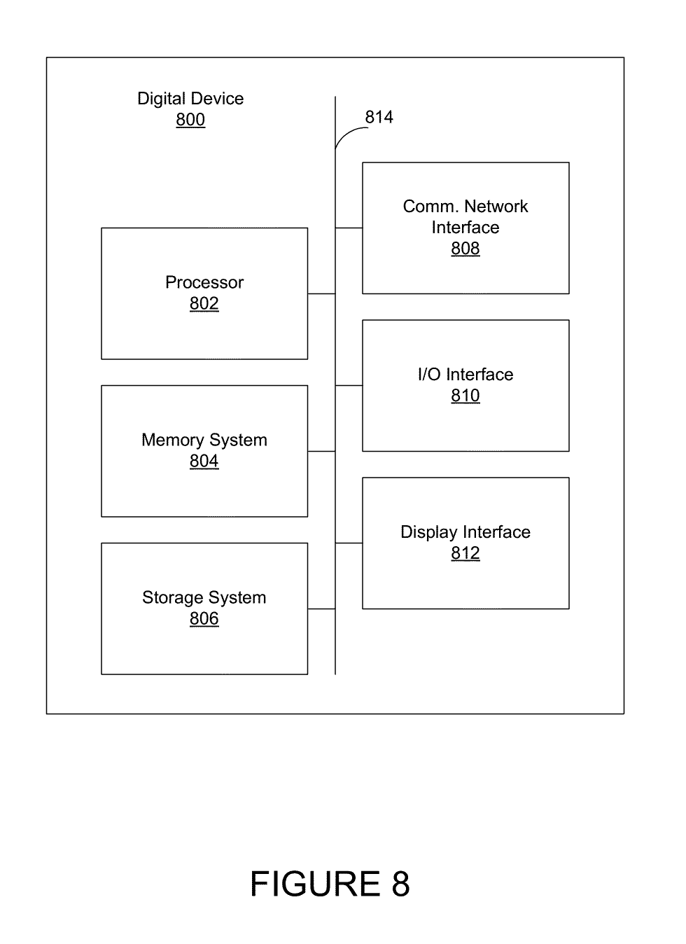

FIG. 1 is a diagram of a network system 100 that includes digital devices for managing content feeds, according to some embodiments. The network system 100 includes a first network device (e.g., access point) 102, a second network device 104, a third network device 106, a fourth network device 108, a user device 110 coupled to the first network device 102, a computer network 112, and a network access server system 114. Each of the first network device 102, second network device 104, third network device 106, fourth network device 108, and network access server system 114 is coupled to the computer network 112. One or more of the first network device 102, the second network device 104, the third network device 106, the fourth network device 108, the user device 110, and the network access server system 114 may include a digital device. A “digital device,” as referred to herein, may include any device having a memory and a processor. An example of a digital device is the digital device 800 shown in FIG. 8.

In the network system 100 shown, the first network device 102, the second network device 104, the third network device 106, and the user device 110 reside in a geographical area 116 (e.g., a nearby area). In the network system 100 shown, the fourth network device 108 and the network access server 115 reside outside the geographical area 116. The geographical area 116 may be surrounded by a geographical boundary 118. In specific embodiments, the geographical boundary 118 defines an immediately nearby geographical area (e.g., a neighborhood within a five mile radius) around the first network device 102 or an intermediate geographical area around the first network device 102 (e.g., a zone within fifty mile radius). In various embodiments, the geographical area 116 corresponds to a circle or sphere around the first network device 102, and the geographical threshold corresponds to a radius of that circle or sphere. It will be appreciated that the geographical area 116 can be of any shape and/or distance. The geographical area 116 and the geographical boundary 118 may be defined using other regular or arbitrary shapes, zip codes, phone numbers, other distances, and/or other factors. In some embodiments, at least a portion of the geographical area 116 is selected automatically and/or by the user device 110.

The first network device 102 may include a first router, bridge, switch, and/or combination thereof. The first network device 102 may manage access to the computer network 112 for one or more devices, such as the user device 110, coupled thereto. In various embodiments, the first network device 102 manages a first wireless network, e.g., a WiFi network. The first network device 102 may be administered by a first entity within the geographical area 116, such as a restaurant, hotel, airport, or café within the geographical area 116. The first network device 102 may support network access protocols administered by the network access server system 114.

In some embodiments, the first network device 102 provides the user device 110 with a first splash screen having a first content feed. The first content feed may content items generated and/or applicable within a predetermined distance of the first network device 102. The network access server system 114 may generate and provide the first content feed to the first network device 102. In some embodiments, the content feed may be provided as a splash screen for the first network device 102. In other embodiments, the content feed may be provided via an application on the user device 110.

In some embodiments, the network access server system 114 allows the user device 110 to identify a relevant geographical area for the content feed. For example, the network access server system 114 may provide one or more user interface elements, such as buttons, that allow the user device 110 to select the geographical area. In other embodiments, the network access server system 114 may select the geographic area automatically to enable particular quality of service, number of content items, etc. The first content feed may contain interactive content items, such as a chat function, and/or non-interactive content, such as reviews promotions, advertisements, etc. about points of interest within the geographical area 116.

The network access server system 114 may select content items for the first content feed according to selection criteria. In some embodiments, the content items are selected based on the time the content items were generated, the distance from the first network device 102 where they were generated, the number of content items to be displayed, and/or some combination thereof.

In some embodiments, the network access server system 114 may gather all content items generated by user devices connected to the first network device 102 (e.g., chat commentary generated within a particular Starbuck's venue). In some embodiments, the network access server system 114 may gather all content items generated by user devices connected to network devices within the geographical area 116. In some embodiments, the network access server system 114 may gather all content items generated by user devices connected to related network devices (e.g., chat commentary generated within all Starbuck's venues). In some embodiments, the network access server system 114 may gather content items generated on review sites such as Yelp™ for the particular establishment or nearby establishments. If the number of content items being generated at the particular establishment is insufficient, the network access server system 114 may gather content items from a variable range of neighboring establishments based on the number of available content items. In some embodiments, the network access server system 114 may provide the user device 110 with content items gathered from locations outside the geographical area 116 if an insufficient amount of content was generated within the geographical area 116.

The network access server system 114 may select content items based on selection criteria that limit the number of interactive content items that can be displayed at a specific time in the first content feed.

In some embodiments, the content items may be generated by an entity (e.g., the owner or manager) associated with the first network device 102, the second network device 104, the third network device 106, the fourth network device 108, etc. The network access server system 114 may select the information, advertisements, and/or promotions generated by an owner or manager of the restaurant, hotel, airport, or café that maintains one of the network devices for the content feed. The network access server system 114 may allow the entity to moderate (curate, edit, filter, etc.) the content items selected for the content feed. In other words, the network access server system 114 may allow the entity to allow and/or block content items. For example, the network access server system 114 may use first entity preference information to block content items on the first content feed that include edited negative reviews of the entity, promotions of competitors, chat comments generated at competitor establishments, etc. In various embodiments, the network access server system 114 may enable the entity to delete content items from the database of content items maintained by the network access server system 114.

In various embodiments, the network access server system 114 may allow a user to generate content items into the content feed. In various embodiments, the user can add new content items, edit existing content items, and/or deleting existing content items. For example, the network access server system 114 may allow a user of the user device 110 to provide new comments, reviews, ratings, other user-generated information related to a specific location in the geographical area 116. The specific location may correspond to the establishment or a portion of the establishment administering the first network device 102. In various embodiments, the user generated content is provided to the network access server system 114, which incorporates the user generated content into the content feed or feeds displayed by user devices coupled to the first network device 102, the second network device 104, the third network device 106, and/or the fourth network device 108.

The second network device 104 may include a second router, a bridge, a switch, or some combination thereof. The second network device 104 may manage access to the computer network 112 for one or more devices coupled thereto. The second network device 104 may manage a second wireless network for an area around it. The second network device 104 may be administered by a second entity within the geographical area 116. In various embodiments, the second network device 104 may provide a user device coupled thereto with a second content feed.

The third network device 106 may include a third router, a bridge, a switch, or some combination thereof. The third network device 106 may manage access to the computer network 112 for one or more devices coupled thereto and may be similar in operation to the other network devices depicted in the network system 100. The third network device 106 may support a third content feed having geographically targeted information.

The fourth network device 108 may include a fourth router, a bridge, a switch, or some combination thereof. The fourth network device 108 may manage access to the computer network 112 for one or more devices coupled thereto and may be similar in operation to the other network devices depicted in the network system 100. Unlike the other network devices in the network system 100, the fourth network device 108 is located outside the geographical area 116. The fourth network device 108 may support a fourth content feed that is similar to the other content feeds described in conjunction with FIG. 1 in that the fourth content feed may provide content items from user devices coupled or proximate to the fourth network device 108. In some embodiments, the fourth content feed does not contain content items related to the geographical area 116. Rather, the fourth content feed may contain content items related to nearby geographic areas. In other embodiments, the fourth content feed may include the same, a subset and/or a superset of the content items contained in the first content feed.

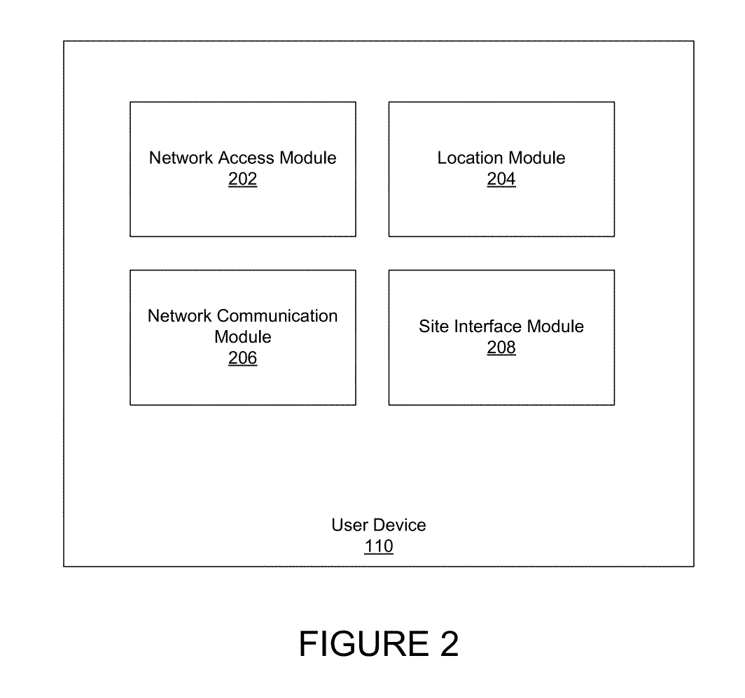

The user device 110 may include any digital device that allows a user to access the computer network 112. In various embodiments, the user device 110 includes one or more of a mobile phone, a tablet computing device, a laptop computer, and a desktop computer. FIG. 2 shows additional details of the user device 110.

The computer network 112 may include any computer network. The computer network 112 may include wireless and/or wired networks and/or may employ technologies such as Ethernet, 802.11, worldwide interoperability for microwave access (WiMAX), 3G, 4G, CDMA, GSM, LTE, digital subscriber line (DSL), etc. The computer network 112 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the computer network 112 may be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

The network access server system 114 may support for the network devices in the network system 100, including the first network device 102, the second network device 104, the third network device 106, and the fourth network device 108. In various embodiments, the network access server system 114 manages the content feeds for the network devices in the network system 100. The network access server system 114 may also verify credentials of the user devices in the network system 100, such as the user device 110.

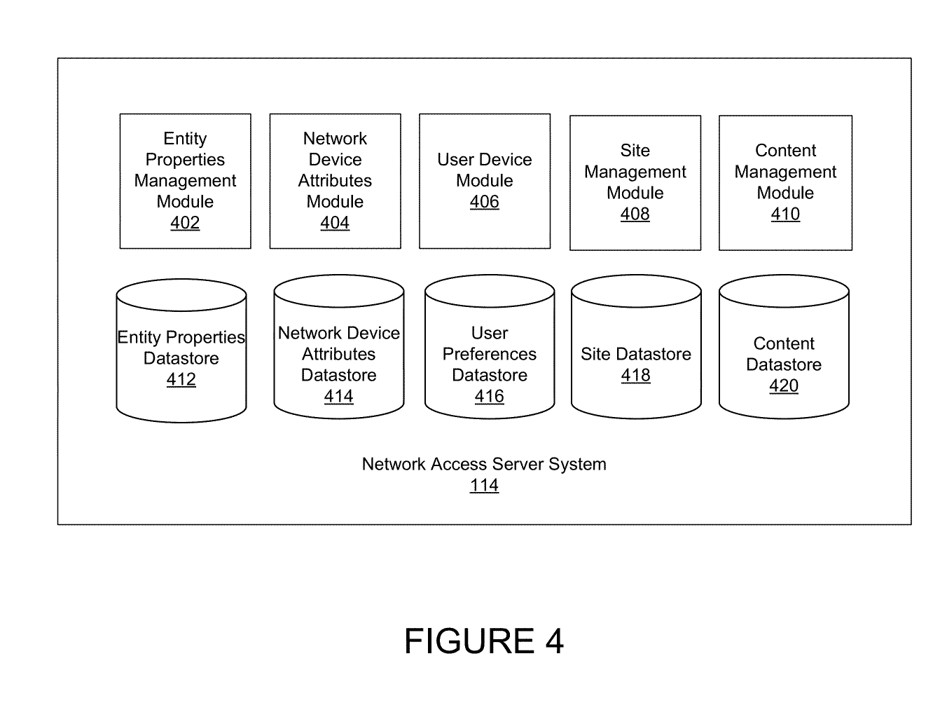

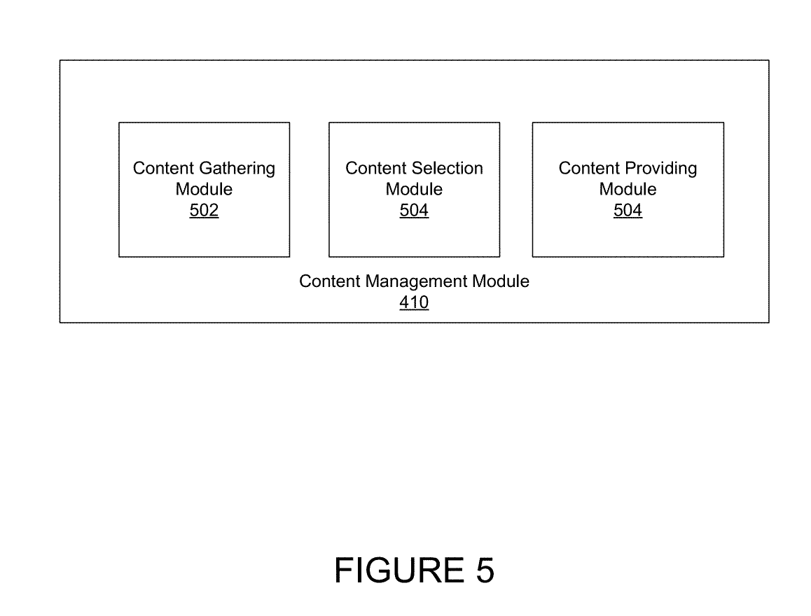

In some embodiments, the network access server system 114 provides content feeds for the network devices in the network system 100. For example, the network access server system 114 may receive user generated content from user devices coupled to the first network device 102, the second network device 104, the third network device 106, and/or the fourth network device 108. The network access server system 114 may use the user generated content as the basis of content items for the content feeds supported by the respective network devices. FIG. 4 and FIG. 5 show additional details of the network access server system 114.

FIG. 2 is a diagram illustrating details of a user device 110, according to some embodiments. The user device 110 includes a network access module 202, a location module 204, a network communication module 206, and a site interface module 208. One or more of the network access module 202, the location module 204, the network communication module 206, and the site interface module 208 may include hardware, firmware, or software, or some combination thereof.

The network access module 202 manages network access for the user device 110. The network access module 202 may maintain access credentials (e.g., a username, password, and/or a device identifier) used to access the network access server system 114. The network access module 202 may identify particular network devices in range automatically and/or manually.

The location module 204 may determine geographic coordinates of the user device 110. In some embodiments, the location module 204 cooperates with a geography-based transmitter, such as a Global Positioning System (GPS) or Bluetooth Low Energy (BLE) module.

The network communication module 206 may allow the user device 110 to communicate with a network device. For example, the network communication module 206 may send and receive access credentials, geographic coordinates, and user generated content related to sites (content feeds). More specifically, the network communication module 206 sends geographic coordinates obtained by the location module 204. Further, the network communication module 206 may send user input (e.g., user generated content, user preferences, etc.) related to content items and/or content feeds to the network access server system 114 and may receive content items from the network access server system 114.

The site interface module 208 may support display of the first content feed on the user device 110. In various embodiments, the site interface module 208 supports at least a portion of a web browser or a mobile application installed on the user device 110. The site interface module 208 may receive user input from the user of the user device 110. In some embodiments, the site interface module 208 allows the user to select a geographic area for the content feed. For example, the site interface module 208 may provide a user with a graphical user interface (GUI) that allows the user to select the establishment, an immediately nearby geographical area, an intermediately nearby geographical area, etc. for the content feed. The site interface module 208 may allow the user to specify the number of content items that the user wishes to display on the display screen. The site interface module 208 may also specify any arbitrary geographical area for the entry site.

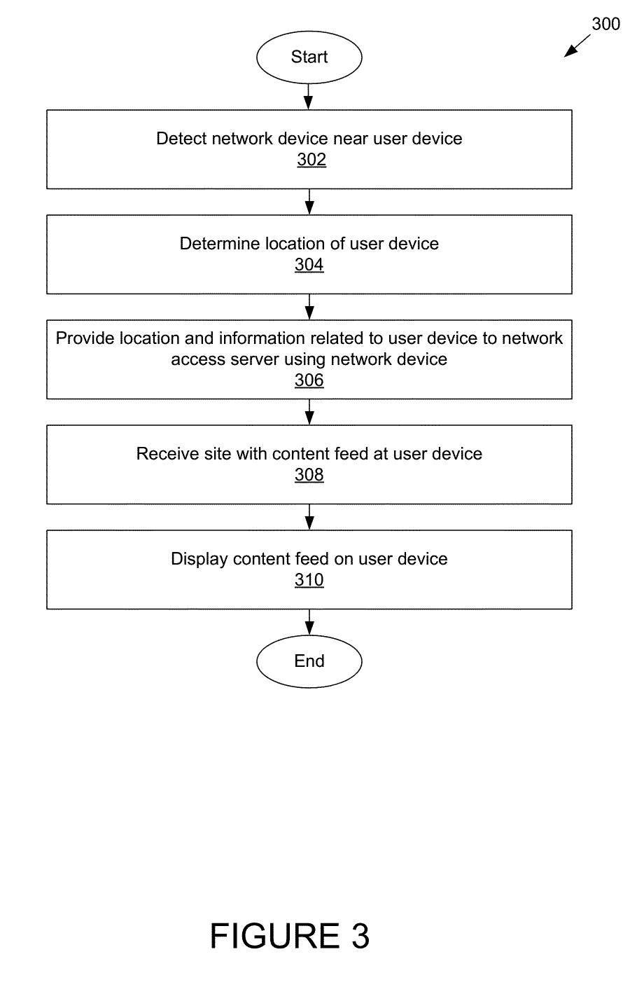

FIG. 3 is a diagram of a method 300 for providing a content fed to a user device, according to some embodiments. The method 300 is discussed in conjunction with the user device 110, shown in FIG. 1 and FIG. 2.

At step 302, the network access module 202 detects a network device near the user device 110, such as the first network device 102. In some embodiments, the network access module 202 polls the vicinity of the user device 110 for network devices that indicate a wireless network is available. If a network device indicates a wireless network is available, the network access module 202 provide a device identifier and other information to the network device so that the user device 110 can connect to the computer network 112. The network access module 202 may provide this information to the network communication module 206.

At step 304, the location module 204 determines a location of the user device 110. More specifically, the location module 204 may use a GPS or BLE module to determine an approximate location of the user device 110. The location module 204 may provide the location of the user device to the network communication module 206.

At step 306, the network communication module 206 provides the location and information related to the user device 110 to the network access server system 114 using the first network device 102. The network access server system 114 may receive this information and provide it to the network access server system 114 over the computer network 112.

At step 308, the site interface module 208 may receive the first entry site, including a content feed for the first site, for display on the user device 110. In various embodiments, the first entry site includes geographically targeted data content. The geographically targeted content may include content associated with other entities within the geographical area 116. In some embodiments, the content feed may include content items associated with entities outside the geographical area 116, as discussed herein.

At step 310, the site interface module 208 may display the content feed on the user device 110. More specifically, the site interface module 208 may provide content items (related to entities within the geographical area 116 or related to entities outside the geographical area 116) in the content feed. The entry site and the content feed may be displayed on the browser and/or mobile application on the user device 110. The site interface module 208 may further allow the user of the user device 110 to provide user input into the content feed. For example, the site interface module 208 may receive comments, ratings, or other user-generated information related to the entity that administers the first network device 102. As another example, the site interface module 208 may allow the user of the user device 110 to navigate away from the first entry site and perform other tasks, such as web browsing and use of networked resources by applications on the user device 110.

FIG. 4 is a diagram illustrating details of a network access server system 114, according to some embodiments. The network access server system 114 includes an entity properties management module 402, a network device attributes module 404, a user device module 406, a site management module 408, a content management module 410, an entity properties datastore 412, a network device attributes datastore 414, a user preferences datastore 416, a site datastore 418, and a content datastore 420. One or more of the entity properties management module 402, the network device attributes module 404, the user device module 406, the site management module 408, the content management module 410, the entity properties datastore 412, the network device attributes datastore 414, the user preferences datastore 416, the site datastore 418, and the content datastore 420 may include hardware, firmware, or software, or some combination thereof.

The entity properties management module 402 manages properties of entities that administer network devices. More specifically, the entity properties management module 402 may include entity credential information, such as an entity's name and password, or other information that would allow an entity to be identified by the network access server system 114. The entity properties management module 402 may further allow an entity to create and/or manage content items. For example, the entity properties management module 402 may allow an entity to moderate, curate, and/or delete content items. In some embodiments, the entity properties management module 402 allows an entity to manage rules (e.g., filters) for providing content items. The entity properties management module 402 stores the information in the entity properties datastore 412.

The network device attributes module 404 identifies attributes of specific network devices, such as the names, identification numbers, and/or locations of specific network devices. In various embodiments, the network device attributes module 404 receives from a network device its associated Subscriber Station Identifiers (SSID). The network device attributes module 404 may use the SSID to look up the location of the network device based on tables and/or other information in the network device attributes datastore 414. For example, the network device attributes module 404 may correlate the SSID geographic coordinates to identify the locations of other nearby specific network devices and/or to identify content items generated nearby. In some embodiments, the network device attributes module 404 provides information related the locations of network devices to the other modules of the network access server system 114.

The user device module 406 identifies and/or verifies preferences of specific users and/or specific user devices. In various embodiments, the user device module 406 receives credentials from user devices. The user device module 406 may also receive geographic coordinates, such as GPS coordinates or BLE data, from specific user devices. In some embodiments, the user device module 406 verifies the credentials of the specific user devices to allow the specific user devices to access the computer network 112. In various embodiments, the user device module 406 provides identifying information (e.g., the identity of the user device, the credentials of the user device, the position of the user device) related to the specific user device to the other modules of the network access server system 114. The user device module 406 stores the information in the user preferences datastore 416.

The site management module 408 provides web services and supports a user interface of sites on the user devices shown in the network system 100. The site management module 408 may further gather the content feed for the site from the content management module 410. The site management module 408 manages providing the first content feed, the second content feed, the third content feed, the fourth content feed, etc. The site management module 408 stores the information for the site in the site datastore 418.

The content management module 410 may manage gathering, storing, selecting and providing content items for sites. The content management module 410 may gather all content items generated over all network devices and store the content items in the content datastore 420. The content management module 410 then can select appropriate content items for a content feed based on selection criteria from the content datastore 420, and provide the content feed to the other modules of the network access server system 114. In some embodiments, the content management module 410 may gather content items from websites, e.g., Yelp™, which it provides into its content feed. FIG. 5 shows details of the content management module 410. The content management module 410 stores the information in the content datastore 420.

FIG. 5 is a diagram illustrating details of a content management module 410, according to some embodiments. The content management module 410 includes a content gathering module 502, a content selection module 504, and a content providing module 506. One or more of the content gathering module 502, the content selection module 504, and the content providing module 506 may include hardware, firmware, software, or some combination thereof.

The content gathering module 502 gathers information from user device, entities associated with network devices, and/or other sources, and stores this information in the content datastore 420. The content gathering module 502 may receive content items from sites, e.g., user-generated comments, reviews, ratings, messages, etc. The content gathering module 502 may gather the content items as the content is generated by user devices over the network devices. In some embodiments, the content gathering module 502 receives advertisements, promotions, etc. from entities that administer network devices. Further, the content gathering module 502 may gather content from other sources, such review websites, message boards, and other websites. The gathered information may be stored in the content datastore 420.

The content selection module 504 selects content items for a user device based on selection criteria, which may include the location of the network device and/or the location of the user device. In some embodiments, the selection criteria does not include the geographic location information. It may include entity information, e.g., the brand. The selection criteria may be related to the date/time that content items were generated, the distance from the network device and/or the user device where the content items were generated, the number of content items available for display on the user device at a given time, and/or some combination thereof. The content selection module 504 may also use the selection criteria to sort content items. Selection criteria may also include entity preferences, e.g., rules (filters), that control whether content items may be displayed on its user devices connected to the network device.

The content selection module 504 may select content items generated within a specified threshold of time (e.g., a specified number of seconds, minutes, hours, days, weeks, etc.). The content selection module 504 may select content items that are older than a specified threshold, or that fall within a specified window of time.

In various embodiments, the content selection module 504 uses selection criteria based on locations referenced by the content items. For example, comments, reviews, or messages may be related to specific venues within a specified geographical area. The selection criteria may specify content items relating to points of interest within a specified distance of the user device 110. The specified distance may or may not correspond to the geographical area 116. The selection criteria may specify content items gathered outside the specified distance of the user device 110, or may specify no geographical limitations whatsoever.

In specific embodiments, the content selection module 504 uses selection criteria that controls the number of content items that can be displayed at a specific time on a site. The number of content items may include, for instance, smaller numbers of content items that make it convenient to display content on user devices or a minimum number of content items to capture interest.

The content selection module 504 may determine whether there are a specified number of content items related to a relevant geographical area, such as the immediately nearby geographic area (e.g., within 5 miles) around a network device. If so, the selection criteria may select those content items. If not, the selection criteria may gather content items related to larger geographical areas (e.g., within 50 miles) around the network device until the specified number of content items are identified. Such embodiments may prove advantageous to user devices that seek content items in a specific geographic area, but find an “empty wall” due to a lack of content items within the specific geographic area.

The content selection module 504 may select and sort content items related to a first geographic area according to first selection criteria and sort content items related to a second geographic area according to second selection criteria. For example, the content selection module 504 may sort content items related to closer locations in the first geographic area higher than content items related to farther locations in the first geographic area. The content selection module 504 may further select and sort content items in a second geographical area, such as an intermediate geographical area or around the world, according to second selection criteria, such as the times the content items were generated and the number of content items available for display.

The content providing module 506 provides selected content items to the other modules of the network access server system 114. In some embodiments, the content providing module 506 formats selected content items as a content feed or other format that can be displayed on a user device.

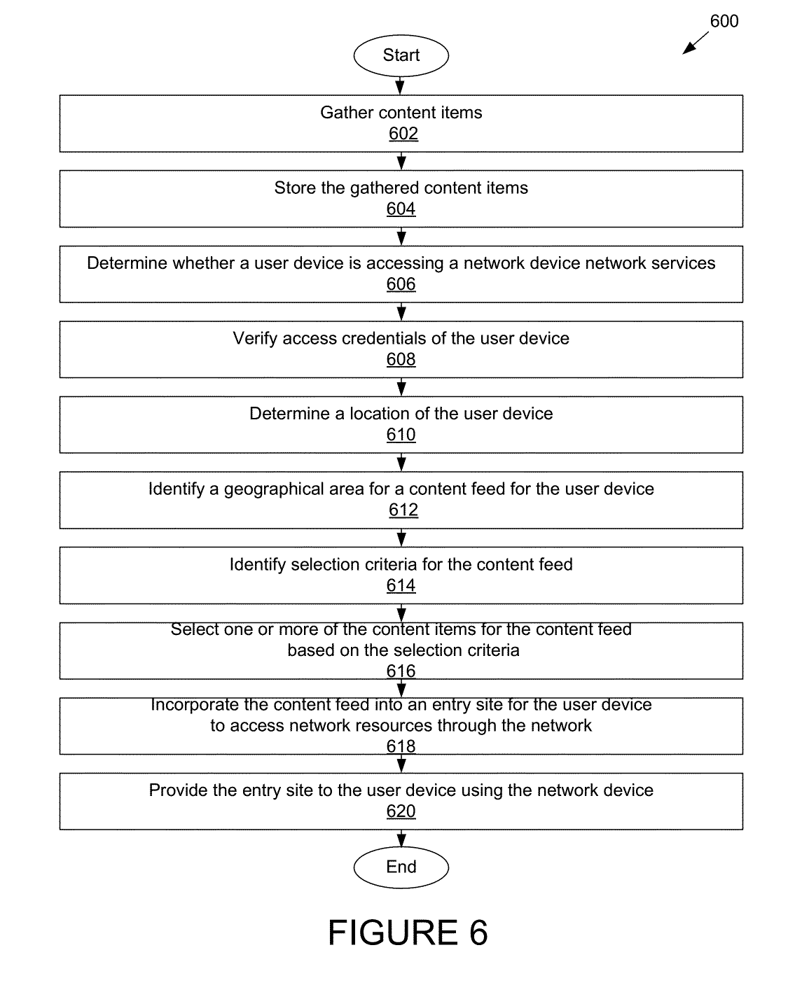

FIG. 6 is a diagram of a flowchart of a method 600 for providing a content feed from a network access device, according to some embodiments. The method 600 is discussed in conjunction with the content management module 410, shown in FIG. 4 and FIG. 5 and discussed further herein.

At step 602, the content gathering module 502 gathers content items. In some embodiments, the content gathering module 502 gathers content items from other user devices. The other user devices may or may not be in the geographical area 116 (i.e., the same geographical area as the first network device 102). The content gathering module 502 may also gather content items from entities inside the geographical area 116 and/or entities outside the geographical area 116. In some embodiments, the content gathering module 502 gathers content from review sites and/or other sites that may contain relevant content.

At step 604, the content gathering module 502 stores the gathered content items in the content datastore 420. More specifically, the content gathering module 502 may store at least some of the gathered content items in the content datastore 420. In some embodiments, the content gathering module 502 need not store gathered content but may instead provide it to other modules of the content management module 410.

At step 606, the user device module 406 determines whether a user device is accessing a network device network services. More specifically, the user device module 406 may identify a request by the user device 110 to access the first network device 102. The request may be related to an attempt by the user device 110 to access the wireless network administered by the first network device 102. The request may also come from a manual request by the user of the user device 110 to access various network resources or the computer network 112.

At step 608, the user device module 406 verifies access credentials of the user device. The user device module 406 may verity a username, password, device identifier (e.g., a Media Access Card (MAC) Address or other identifier). The user device module 406 may inform other modules whether or not credentials of the user device 110 have been verified to warrant access to network resources.

At step 610, the user device module 406 and/or or the network device attributes module 404 determine a location of the user device 110. In some embodiments, the user device module 406 receives geolocational data (e.g., GPS coordinates or BLE information) from the user device 110. A location may be determined based on that information. In specific embodiments, the network device attributes module 404 determines a location of the user device 110 based on a known location of the first network device 102. Further, in various embodiments, the user device module 406 and the network device attributes module 404 cooperate to determine the location of the user device 110. To this end, the user device module 406 may receive geolocational data from the user device 110, and the network device attributes module 404 receives an SSID or other information of the first network device 102. The geolocational data and the information from the first network device 102 may be used to determine the location of the user device 110.

At step 612, the site management module 408 identifies a geographical area for a content feed for the user device. More specifically, the site management module 408 may identify a geographical area which a user of the user device 110 is likely to be interested in seeing content items for. In embodiments, a walkable area, such as an area having a five mile radius, is identified. In embodiments, a drivable area, such as an area having a fifty mile radius, is identified. Other geographical areas, such as geographical areas corresponding to municipalities, towns, counties, states, and countries, may similarly be identified. It is noted an arbitrary shape can be used as a the basis of an identified geographical area as well.

At step 614, the content selection module 504 identifies selection criteria for the content feed. The selection criteria may be related to the date/time that content items were generated, the distance from the network device and/or the user device where the content items were generated, the number of content items available for display on the user device at a given time, and/or some combination thereof. The selection criteria may be generated first time or may be retrieved based on selection criteria that was previously used for the user device 110 or other user devices. At step 616, the content selection module 504 selects one or more of the content items for the content feed based on the selection criteria

At step 618, the content providing module 506 incorporates the content feed into an entry site for the user device to access network resources through the network. At step 620, the content providing module 506 provides the entry site to the user device using the network device

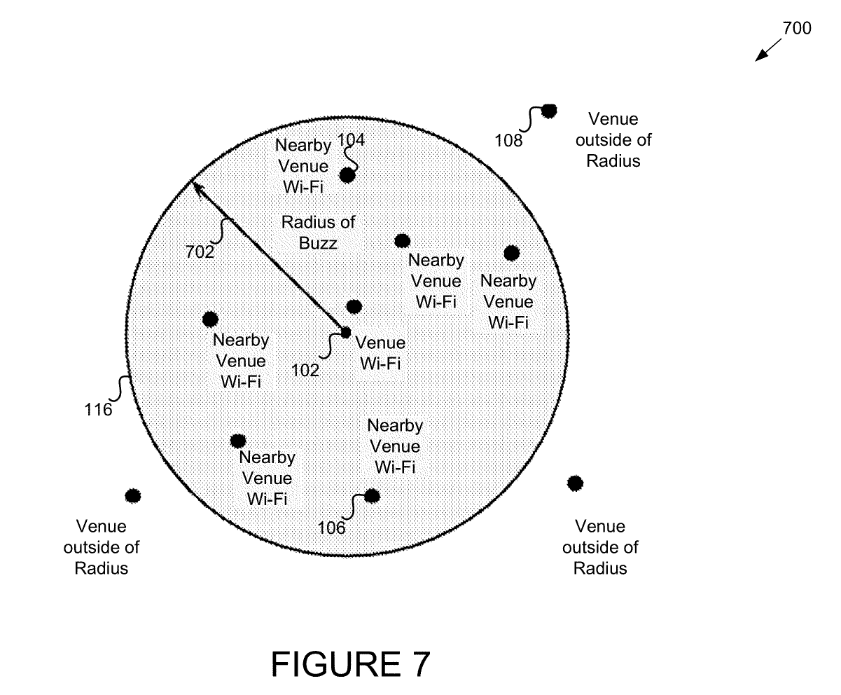

FIG. 7 is a diagram 700 of a geographical area 116. In this embodiment, the geographical area 116 is shown a circle having a radius 702, although any shape area is possible. The first network device 102 is in the center of the geographical area 116. The second network device 104 and the third network device 106 reside within the geographical area 116. The diagram further includes several network devices outside of the geographical area 116, including the fourth network device 108.

FIG. 8 is a block diagram of an exemplary digital device. The digital device 800 comprises a processor 802, a memory system 804, a storage system 806, a communication network interface 808, an input/output (I/O) interface 810, and a display interface 812. The processor 802 is configured to execute executable instructions (e.g., programs). In some embodiments, the processor 802 comprises circuitry or any processor capable of processing the executable instructions.

The memory system 804 is any memory configured to store data. Some examples of the memory system 804 are storage devices, such as RAM or ROM. The memory system 804 can comprise the ram cache. In various embodiments, data is stored within the memory system 804. The data within the memory system 804 may be cleared or ultimately transferred to the storage system 806.

The storage system 806 is any storage configured to retrieve and store data. Some examples of the storage system 806 are flash drives, hard drives, optical drives, and/or magnetic tape. In some embodiments, the digital device 800 includes a memory system 804 in the form of RAM and a storage system 806 in the form of flash data. Both the memory system 804 and the storage system 806 comprise computer readable media (e.g., non-transitory computer readable media) which may store instructions or programs that are executable by a computer processor including the processor 802.

The input/output (I/O) interface 810 is any device that receives input from the user and output data. The display interface 812 is any device that is configured to output graphics and data to a display. In one example, the display interface 812 is a graphics adapter. It will be appreciated that not all digital devices (e.g., any of the devices shown in FIG. 1) comprise either the I/O interface 810 or the display interface 812.

The communication network interface (com. network interface) 808 can be coupled to a network (e.g., computer network 112) via the communication network interface 808. The communication network interface 808 may support communication over an Ethernet connection, a serial connection, a parallel connection, or an ATA connection, for example. The communication network interface 808 may also support wireless communication (e.g., 802.11 a/b/g/n, WiMax). It will be apparent to those skilled in the art that the communication network interface 808 can support many wired and wireless standards.

In various embodiments, systems and methods are described that enable a digital device to automatically select and access an available wireless network from a plurality of available wireless networks based on rules to achieve a satisfactory quality of service. Such rules could be implemented in the digital device itself, on a server in communication with the digital device, or a combination of both. In various embodiments, a wireless network is a network that allows wireless access between a digital device and a communication network such as the Internet.

In accordance with some embodiments, a user of a wireless digital device (e.g., digital device capable of Wi-Fi communication) creates an account on a web server and registers one or more digital devices (e.g., computers, laptops, personal digital assistants, and cell phones) with that account. The registered digital devices can be managed and a network record provisioned by a central server (e.g., a profile server or a credential server) via a network communication mechanism, such as HTTP.

1. A system comprising:
a content gathering module for gathering content items;
a user device module for determining whether a first user device is accessing a first network device configured to provide wireless network access at a first location in a first geographical area;
a site management module for managing a first entry site for the first user device to access network resources through the network device;
a content selection module for selecting one or more of the content items for the first entry site based on selection criteria particular to the first location; and
a content providing module for incorporating the one or more content items into a first content feed, and for providing the first content feed to the user device.

2. The system of claim 1, wherein the gathered content items comprise user-generated content items generated by a second user device within the first geographical area into the first content feed.

3. The system of claim 1, wherein the gathered content items comprise user-generated content items by a second user device outside the first geographical area.

4. The system of claim 1, wherein the gathered content items are generated at least in part by an entity that administers a second network device within the geographical area.

5. The system of claim 1, wherein the selection criteria comprises criteria for selecting the one or more content items based on a time each of the one or more content items was generated, or based on a location each of the one or more content item was generated.

6. The system of claim 1, wherein the selection criteria comprises criteria for controlling a number of the one or more content items in the first content feed.

7. The system of claim 1, wherein the selection criteria comprises first selection criteria for selecting a first content item of the one or more content items, the first content item generated within the first geographical area, and second selection criteria for selecting a second content item of the one or more content items, the second content item generated outside the first geographic area.

8. The system of claim 7, wherein:
the first selection criteria comprises criteria for selecting the first content item based on a location the first content item was generated; and
the second selection criteria comprises criteria for selecting the second content item based on a time the second content item was generated.

9. The system of claim 1, further comprising a network device attribute module for determining the first location based on a network device identifier of the network device.

10. The system of claim 1, wherein the user device module is configured to determine the first location based on location data from the user device.

11. A method comprising:
gathering content items;
determining whether a first user device is accessing a first network device configured to provide wireless network access at a first location in a first geographical area;
managing a first entry site for the first user device to access network resources through the network device;
selecting one or more of the content items for the first entry site based on selection criteria particular to the first location;
incorporating the one or more content items into a first content feed; and
providing the first content feed to the user device.

12. The method of claim 11, wherein the gathered content items comprise user-generated content items generated by a second user device within the first geographical area into the first content feed.

13. The method of claim 11, wherein the gathered content items comprise user-generated content items by a second user device outside the first geographical area.

14. The method of claim 11, wherein the gathered content items are generated at least in part by an entity that administers a second network device within the geographical area.

15. The method of claim 11, wherein the selection criteria comprises criteria for selecting the one or more content items based on a time each of the one or more content items was generated, or based on a location each of the one or more content item was generated.

16. The method of claim 11, wherein the selection criteria comprises criteria for controlling a number of the one or more content items in the first content feed.

17. The method of claim 11, wherein the selection criteria comprises first selection criteria for selecting a first content item of the one or more content items, the first content item generated within the first geographical area, and second selection criteria for selecting a second content item of the one or more content items, the second content item generated outside the first geographic area.

18. The method of claim 17, wherein:
the first selection criteria comprises criteria for selecting the first content item based on a location the first content item was generated; and
the second selection criteria comprises criteria for selecting the second content item based on a time the second content item was generated.

19. The method of claim 11, further comprising determining the first location based on a network device identifier of the network device.

20. The method of claim 11, further comprising determining the first location based on location data from the user device.

21. A system comprising:
means for gathering content items;
means for determining whether a first user device is accessing a first network device configured to provide wireless network access at a first location in a first geographical area;
means for managing a first entry site for the first user device to access network resources through the network device;
means for selecting one or more of the content items for the first entry site based on selection criteria particular to the first location; and
means for incorporating the one or more content items into a first content feed, and for providing the first content feed to the user device.
